(19) United States
(12) Patent Application Publication
(10) Pub. No.: US 2009/0125366 A1
(43) Pub. Date: May 14, 2009

(54) METHOD AND SYSTEM FOR DYNAMIC ADAPTATION OF WORKFLOWS

(76) Inventors: Dipanjan Chakraborty, Kolkata (IN); Amit Anil Nanavati, New Delhi (IN); Vinod V. Mankar, Mumbai (IN); Parul Mittal, Haryana (IN)

Correspondence Address: FREDERICK W. GIBB, III;Gibb Intellectual Property Law Firm, LLC, 2568-A RIVA ROAD, SUITE 304, ANNAPOLIS, MD, 21401, US

(21) Appl. No.: 11/938,872

(22) Filed: Nov. 13, 2007

(51) Int. Cl. G06F 17/30

(52) U.S. Cl. 705/9

(57) ABSTRACT

A workflow management method for a workflow system comprises registering events recognized by one or more workflows in a workflow event registry, registering new dependency information in an event dependency registry, and registering corrective actions in an event handling directives module. Further, upon receipt of an event, the method comprises identifying workflows that have a dependency associated with the received event, forwarding the event to dependent workflows which recognize the event, determining, with reference to the event handling directives module, corrective actions for dependent workflows which do not recognize the event, and instructing, by way of recognized events, the dependent workflows which do not recognize the event to perform the corrective actions.

### FIELD OF THE INVENTION

The present invention relates generally to the control of workflows and, in particular, to the dynamic adaptation of workflows to events that are unknown at design time.

### BACKGROUND

Conventional workflows such as business workflows are capable of handling events that were envisioned at the time of designing the workflows. Typically, during the design of workflows workflow designers pre-empt the occurrence of possible events and define event handlers to handle such events. Such events may be received from different sources internal or external to the workflow. The event handlers are part of the workflow design and are implemented and deployed on a workflow engine.

FIG. 1 illustrates a conventional workflow management system in which an event is sent from an event source 110 to the workflow engine 100 using pre-defined protocols at run-time. For example, if a Business Process Execution Language (BPEL) is used, a web service call is made to a workflow from the event source 110. By way of an event handler encapsulating logic that is executed on the occurrence of the event, the workflow is made aware of the event and instructed on appropriate action to take.

One problem associated with the conventional workflow management system is that event sources need to be homogeneous. That is, event sources need to adhere to event transmission protocols defined by the workflow at the time of design. An event generation source that is ignorant of the proper event transmission protocols is unable to send events to the workflow management system.

Another problem associated with the conventional workflow management system is the lack of support for handling unforseen events that may alter a workflow during run-time. Such events are usually captured by the conventional workflow management system as general exceptions. However, the set of actions defined to handle general exceptions are generic and often unrelated to the type of event that caused the exception. Conventional workflows are generally unable to dynamically inject logic for incorporating new events and corresponding event-handling logic. This often necessitates costly re-planning and redeployment of the workflow.

Specialized workflow engines, utilizing for example Aspect Oriented Programming, capable of dynamically injecting customized logic depending on the occurrence of new events are known. However, such workflow engines are unable to coexist with conventional workflow engines and other specialized workflow engines. Moreover, there are limitations as to exactly at what point in time an event handler can be injected.

The publication by Halliday et al, “Flexible Workflow Management in the OPENflow system”, in Proceedings of the 5th IEEE/OMG International Enterprise Distributed Object Computing Conference (EDOC 2001), Seattle, Wash., USA, 4-7 Sep. 2001, pp. 82-92, 2001, describes ways of achieving flexibility in managing workflow by employing an adaptation approach for handling unforeseen exceptional circumstances. The described OPENflow system provides a distributed transactional execution environment to enable transactional and non-transactional tasks to be composed and executed as non-ACID ‘extended transaction’ workflows. The system provides support for workflow adaptation at the instance level (also known as dynamic reconfiguration). In OPENflow, dynamic reconfiguration mechanisms are provided making use of atomic transactions to add and remove one or more tasks and to allow the addition and removal of dependencies between tasks from a running workflow. Use of transactions ensures that changes are carried out atomically with respect to normal processing. In the OPENflow system, however, only certain modifications are possible, based on certain constraints.

United States Patent Application Publication Number 20040117803A1 describes a method and a system for dynamically specifying exceptions and exception handlers for an application. The method decouples the exception handling logic from the application, whereby the behaviour of the program/module/application can be altered, and new types of exceptions defined, at runtime. In this manner, the exceptions and exception handlers can also be specified at run-time, the behaviour of the application altered at run time, and external exception handlers plugged in as and when required. USPA20040117803A1, however, handles only internal exceptions. and does not address how general external events may be handled by a running workflow. This system is further unable to handle events generated externally.

It would be advantageous if workflows could be dynamically adapted in response to unforseen changes in policies or in the overall system, regardless of the state of the workflow, and preferably with little to no programming effort. This would reduce the time-to-deployment and market each time new changes are made to backend workflow-based system. It would further be advantageous if the downtime involved in introducing changes to workflow systems to handle new requirements and changes could be reduced, and if workflow dependencies could be resolved automatically.

### SUMMARY

According to an aspect of the invention, there is provided a workflow management method for a workflow system comprising registering events recognized by one or more workflows in a workflow event registry; registering new dependency information in an event dependency registry; registering corrective actions in an event handling directives module; upon receipt of an event, identifying workflows that have a dependency associated with the received event; forwarding the event to dependent workflows which recognize the event; determining, with reference to the event handling directives module, corrective actions for dependent workflows which do not recognize the event; and instructing, by way of recognized events, the dependent workflows which do not recognize the event to perform the corrective actions.

According to another aspect of the invention, there is provided a workflow management system comprising a workflow registry adapted to store event handlers defined by workflows; an event dependency registry operable to receive and store new dependency information identifying workflows dependent on an event; and an event handler operable to identify events dependent on a received event, and operable to determine, with reference to the workflow registry a first set of one or more workflows. The workflows of the first set are workflows identified as dependent on the received event and for which an event handler adapted to handle the received event has been defined. The event handler is further operable to forward the received event to the first set of workflows.

### BRIEF DESCRIPTION OF THE DRAWINGS

Some aspects of the background art and one or more embodiments of the present invention will now be described with reference to the drawings and appendices, in which:

FIG. 1 illustrates a conventional arrangement of a workflow management system.

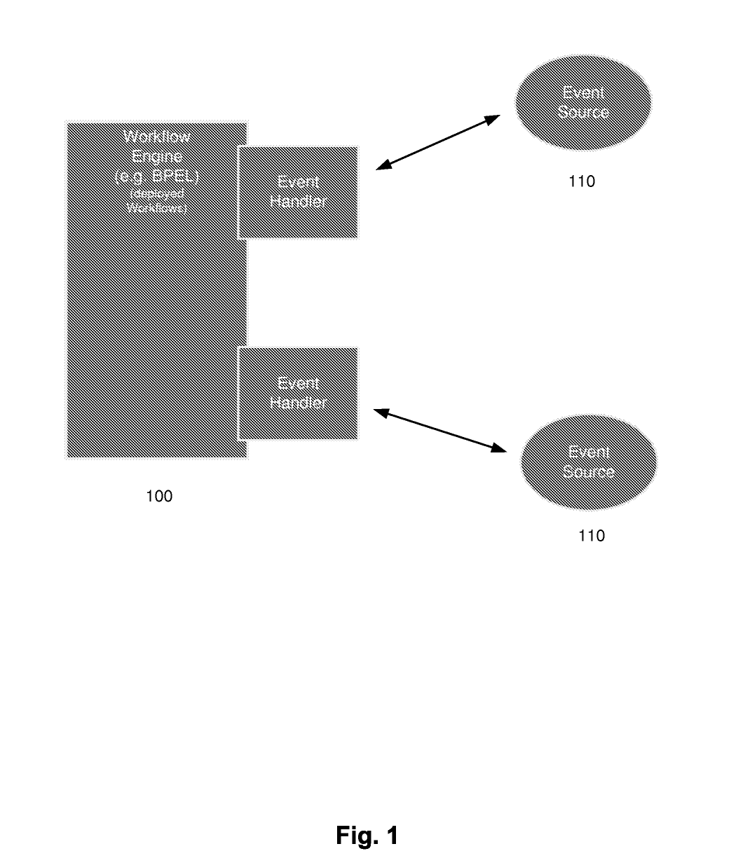

FIG. 2 is a schematic diagram of a system according to one embodiment of the invention.

FIG. 3 is a schematic diagram of an event object.

FIG. 4 is a flow diagram illustrating an operation of the system according to one embodiment.

FIG. 5 illustrates an application of the invention.

FIG. 6 illustrates an application of a conventional workflow system.

Appendix A is a sample BPEL (Business Process Execution Language) code snippet representation of software for a generic event handler

### DETAILED DESCRIPTION

A method and system for dynamically adapting workflows is described. In the following detailed description, reference is made to the accompanying drawings that form a part hereof, and in which is shown by way of illustration a specific exemplary embodiment in which the invention may be practised. The embodiment is described in sufficient detail to enable those skilled in the art to practise the invention. Other embodiments may be utilized, and logical, mechanical, and other changes may be made without departing from the spirit or scope of the present invention. The following detailed description is therefore not to be taken in a limiting sense, and the scope of the present invention is defined only by the appended claims.

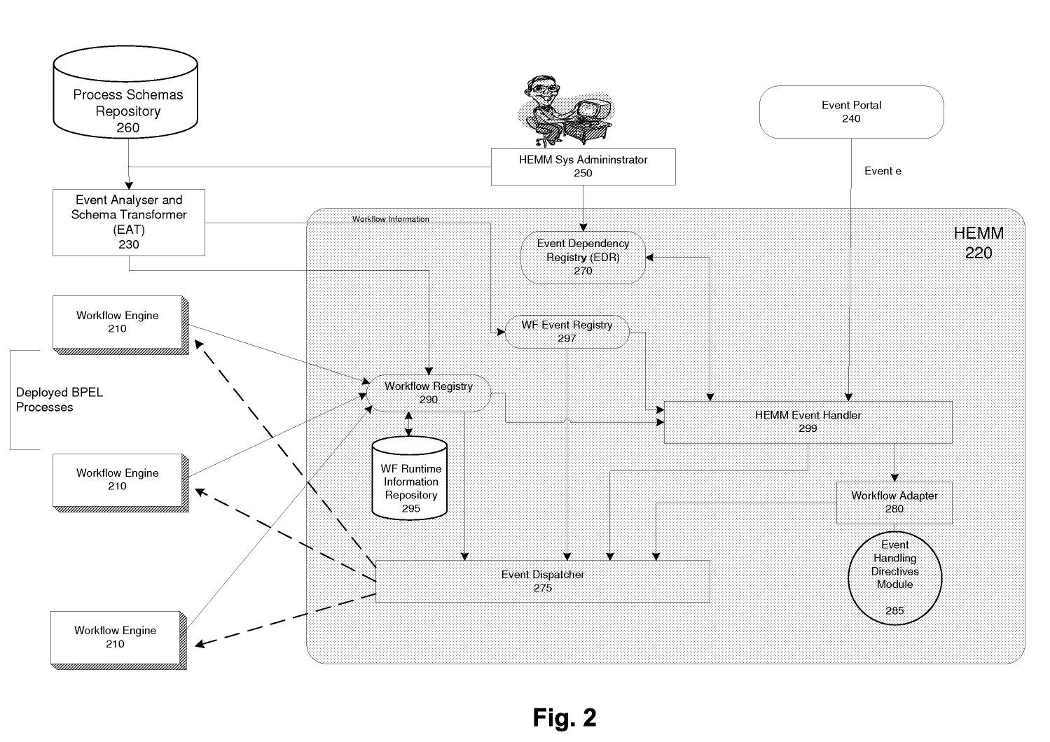

Referring to FIG. 2, an embodiment of the disclosed workflow system and components thereof are described. The workflow system includes workflow engines 210, a heterogeneous event/exception handling middleware (HEMM) 220, an event analyzer and schema transformer (EAT) 230, an event portal 240, a HEMM System administrator 250 and a repository of process schemas 260. As used herein, an event refers to any event or exception whether arising from inside or outside the workflow execution environment.

The HEMM 220 includes an event dependency registry (EDR) 270, an event dispatcher 275, a workflow adapter 280, an event handling directives module 285, a workflow registry 290 connected to a workflow runtime information repository 295, a workflow event registry 297, and a HEMM event handler 299.

The EAT 230 pre-processes workflow schemas to determine the defined events and the possible execution states of the workflows, and registers generic information (address, method names, input messages, output messages, etc.) on the workflows derived from standard-based definitions of the process in the workflow registry 290. Each workflow schema is uniquely identified by a workflow identifier. The EAT 230 further analyzes the workflow schemas to identify basic (e.g. invoke, receive) and structured (e.g. pick, flow) activities, and to identify the sequence of operations where workflows have to wait. These sequences are marked with state identifiers to identify the state of the running process. The identifiers are used by the HEMM 220 to perform the required adaptation upon the receiving unforeseen events at run-time.

The EAT 230 is further responsible for determining the available event handlers in workflows to be deployed and registers the event handlers with the workflow event registry 297. As necessary, the EAT 230 augments a generic event handler and checkpoint code in workflows to be deployed, and also augments workflow logic to allow communication between the workflow registry 290 and the workflow adapter 280. The EAT 230 also augments the workflow schemas with code snippets. Code snippets are inserted in workflow schema to perform the following operations:
(1) Enable the process to interact with the HEMM 220 (specifically the workflow registry 290 and the workflow adapter 280 components of the HEMM).
(2) Add a generic event handler that is used by the event dispatcher 275 of the HEMM 220 to send specific instructions to running workflow instances, and adds the event handler at the process scope to enable the workflow to respond to events at any stage during its execution.
(3) Allow the checkpoint code to update the workflow registry 290 with the value of the state identifiers of the process, whenever a process changes state.

One-time re-deployment of the workflow by the EAT 230 ensures complete decoupling of any unforseen events from a running instance, and allows unforeseen events to be handled using the heterogeneous event handling middleware 220 without a need for any change in backend processes.

The event dependency registry (EDR) 270 primarily stores new dependencies that have resulted due to new requirements, such as the rolling out of new services or introduction of a bundled order, and the like.

The event dispatcher 275 communicates with the workflow registry 290 and the workflow event registry 297 to extract instance-level information, and dispatches instructions in the form of events to appropriate workflow instances. Appropriate workflow instances and corresponding events to be sent thereto are respectively identified and provided to the event dispatcher 275 by the workflow adapter 280. Instructions are transmitted from the event dispatcher 275 to the identified workflow instances using specific protocols and as events understood by the executing workflows instances.

The workflow adapter 280 determines corrective actions and event-handling logic for workflows that have received unforseen events. Event-handling logic and corrective actions for new event dependencies may be specified by the HEMM system administrator 250. The workflow adapter 280 is preferably exposed to running workflows as a web service to ensure interoperability between itself and other web service-based systems. This arrangement also allows the workflow adapter to communicate to workflows in execution, and allows running workflows to call the workflow adapter via web service calls. The workflow adapter 280 is also capable of initiating recovery workflows, which are new workflows that may be initiated/executed to handle exceptions, and mapping an unforseen event to one of the known events using information available in the workflow event registry 297.

Events are received by the workflow adapter 280 from the HEMM event handler 299. The HEMM event handler 299 also sends to the workflow adapter 280 dependencies to be addressed by an event, and the instance IDs identifying the executing workflows that are affected by the event. The workflow adapter 280 refers to the event handling directives module 285 to determine corrective action for events for which an event handler has not been defined in a workflow. Corrective actions that are taken for events are logged for future references to the same event, and corresponding event corrective action (ECA) rules are added to the event handling directives module 285. The workflow adapter 280 combines sets of atomic actions, which collectively form complex actions to effect the corrective actions. Such actions may be encapsulated as separate workflows, referred to as recovery workflows. An atomic action in this context refers to an action or event that can be mapped to or recognized by an event handler already defined in a dependent workflow. The workflow adapter 280 hence maps atomic actions to the available event handlers of the dependent workflow.

Atomic actions are dispatched to appropriate workflow instances via the event dispatcher 275 in the form of events. The event dispatcher 275 refers to the workflow registry 290 and the workflow event registry 297 to extract instance-level information of the workflow instance. The event dispatcher 275 receives from the workflow adapter 280 an instance ID of the workflow instance along with the event to be dispatched, and dispatches the event to the identified workflow instance. The instance ID is a unique identifier used to identify a workflow instance that is executing in the workflow engine.

The event handling directives module 285 stores directives that determine the corrective actions to be taken in response to an event received for a workflow instance to be adapted. The directives are specified by the HEMM system administrator 250 and can be changed, added, deleted at any time while the workflow is deployed. Each directive is modelled using an ECA paradigm. The affected workflow identifier(s) and workflow state(s) determine the condition for each event. For example, the action to take may be an XML-type representation of the atomic events following an enhanced BPEL and WSDL schema to include process identifier specific information. Note that, the HEMM 220 is independent of the format and the complexity of the action to be taken. Appropriate action handlers in the workflow adapter 280 are written, at anytime after the workflow has been deployed in the workflow engine, to handle each action format. By decoupling event handling from the workflow instance, the platform is able to specify actions at run-time while a workflow is executing. The operation of the event handling directives module 285 is not restricted by the HEMM 220. The event handling directive module 285 may be replaced with a complex reasoning engine or a simple table.

The workflow registry 290 stores generic information regarding each deployed workflow schema required to send events to a running workflow instance. Such information includes address, method names, input messages, output messages, and the like. The workflow registry 290 is preferably exposed as a web service, and is used by checkpoint code in running workflow instances to update their states when a change in state occurs. Every executing BPEL workflow registers its instance with the workflow registry 290. This information is kept in the workflow runtime information repository 295. On initiation, a workflow instance registers its workflow name, instance ID and state (e.g. ‘bandwidth provisioning’ for a voice service) with the workflow registry 290. The instance ID is a unique identifier for each instance. The workflow event registry 297 contains information on all events accepted by workflows.

The event portal 240 provides a common platform for siloed backends to send events to the middleware. Siloed backends are backend components that are not integrated with each other, and are not capable of interacting with each other. The event portal 240 integrates with the HEMM 220.

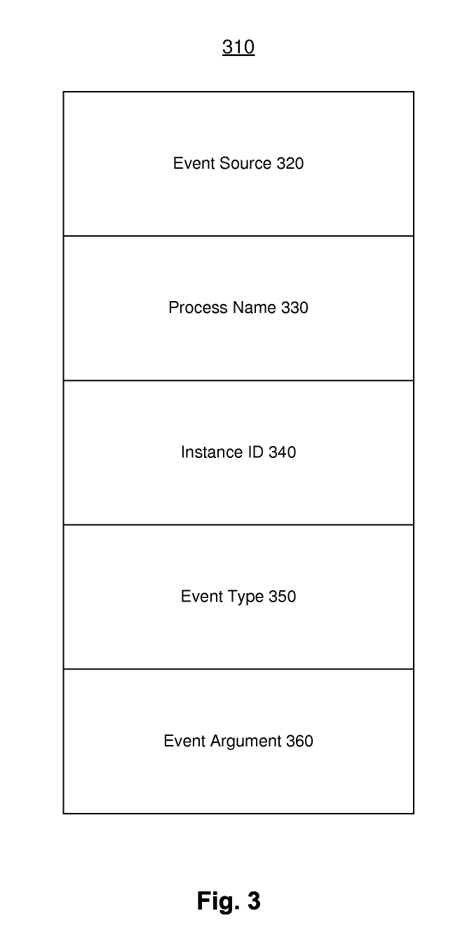

FIG. 3 depicts an event object 310. The event object 310 is a structure allowing the event portal 240 to provide information about events to the HEMM 220. Information can be provided to the HEMM 220 for example over a TCP/IP connection. The event object 310 comprises an event source 320, a process name 330, an instance ID 340, an event type 350, and an event argument 360. The event source 320 specifies the source of the event, for example, the event portal 240. The process name 330 contains the name of the process to which the event object is related. The process name may, for example, be a Business Process Execution Language (BPEL) process name. The instance ID 340 describes a unique identifier of the process instance. The event type 350 identifies the type of the event object 310. The event argument 360 specifies any parameters associated with the event object 310, and may be used to pass arguments along with the event object.

Events that are already known to the workflows typically are raised by customized clients that follow certain standards (e.g. Web Service Description Language) to send such events to the workflows. External events on the other hand are received via the event portal 240. The event portal 240 is operable to send both known events, and unforeseen events. Events received by the event portal 240 are sent to the HEMM event handler 299 as an event object 310. Dependencies arising out of the new/unforeseen events are registered in the event dependency registry 270 by the HEMM system administrator 250. Whenever an event is received by the HEMM event handler 299, the HEMM event handler 299 checks the dependencies of the received event with respect to the workflows to identify dependent workflow instances. The HEMM event handler 299 also checks with the workflow event registry 297 to determine if a corresponding event handler already exists with the executing workflows. If instances of affected workflow are currently executing, the HEMM 220 uses the event handling directives 285 to determine the right/correct set of actions to take for the unforeseen event. Such actions are typically complex actions, requiring multiple atomic actions some of which can be transformed to events that the running workflows are capable of handling. The HEMM 220 identifies such events and dispatches them to the respective workflow instances. Actions that cannot be mapped to known events in the deployed workflows or that cannot be executed by the deployed workflows are executed by the HEMM 220.

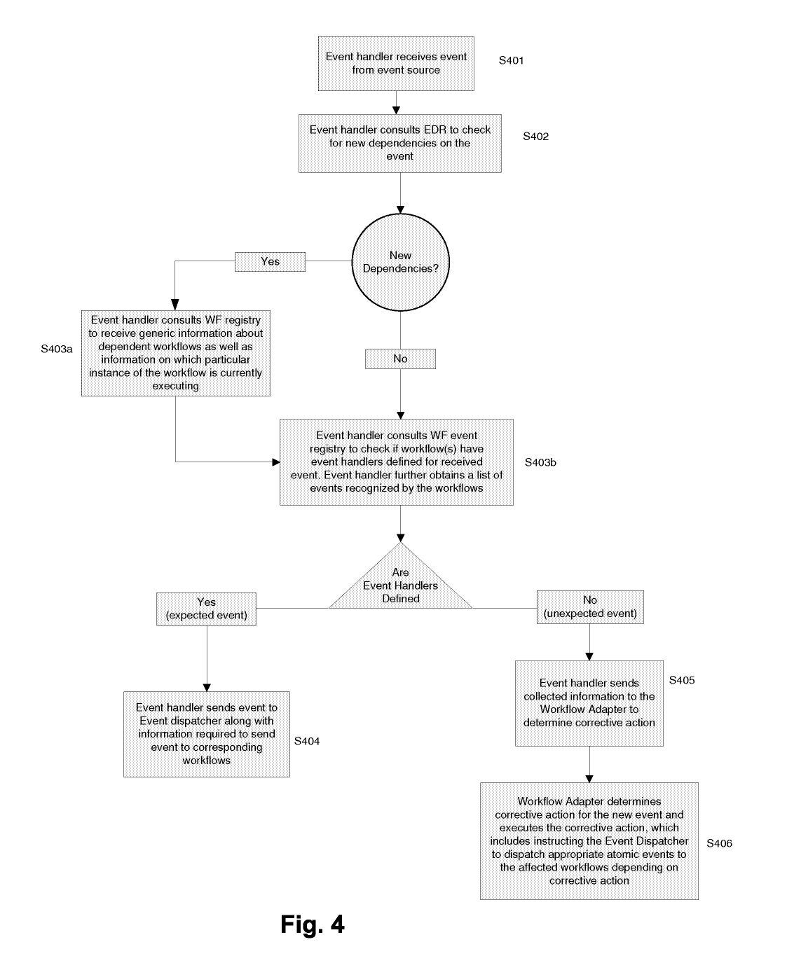

An operation of the workflow system is described with reference to FIG. 4. At block S401, an event from the event portal 240 is received by the HEMM event handler 299. Upon receipt of the event, the HEMM event handler 299 checks the event dependency registry (EDR) 270 for dependencies on the event (block S402). If one or more dependencies are found (S403a), the HEMM event handler 299 consults the workflow registry 290 to receive generic information about dependent workflows as well as information on which particular instance of the workflow is currently executing. Thereafter, or if no dependencies were found, the HEMM event handler 299 consults the workflow event registry 297 to determine which of the workflows affected by/dependent on the received event have event handlers defined for the received event (s403b). The HEMM event handler 299 further obtains from the workflow event registry 297 a list of events recognized by the workflows.

If one or more workflows have event handlers defined for the received event, the HEMM event handler 299 sends the received event to the event dispatcher 275 along with previously collected information required to send the event (such as the dependencies to be addressed, an instance ID, and other information from the workflow registry 290), to these workflows (S404). Conversely, for workflows for which event handlers have not been defined for the received event, the HEMM event handler 299 sends the previously collected information to the workflow adapter 280 to determine corrective actions (S405). At block S406, the workflow adapter 280 determines with reference to the event handling directives module 295 corrective action for the new event and executes the corrective action. The corrective action is executed by, for example, instructing the event dispatcher 275 to dispatch appropriate atomic events to the affected workflows requiring corrective action.

In the above manner, and in particular with the addition of the HEMM 220 and EAT 230 in the workflow system, the workflow system can dynamically adapt to new event dependencies. Unexpected events may be handled without requiring re-planning and re-deployment of the workflow as is necessary with conventional systems.

The HEMM 220 provides the capability to add new events at run-time to an executing workflow without requiring downtime and/or re-programming and/or re-deployment of the executing work-flow. As described above, no changes are required to be made to the executing workflow which has already been deployed in the engine. In particular, it is not required to undeploy, or re-program the executing workflow when there a new event arises in relation to the executing workflow. Instead, the HEMM system administrator is able to introduce the new dependency and specify corrective actions to handle the dependency. This may occur at run-time. With the HEMM 220 a one-time deployment of workflows is hence possible, as opposed to a downtime and a redeployment of workflows each time a change is introduced to the design requirements, or when new events are to be handled. The need for redeployment and reprogramming to handle future changes in requirements and unforeseen events is hence avoided.

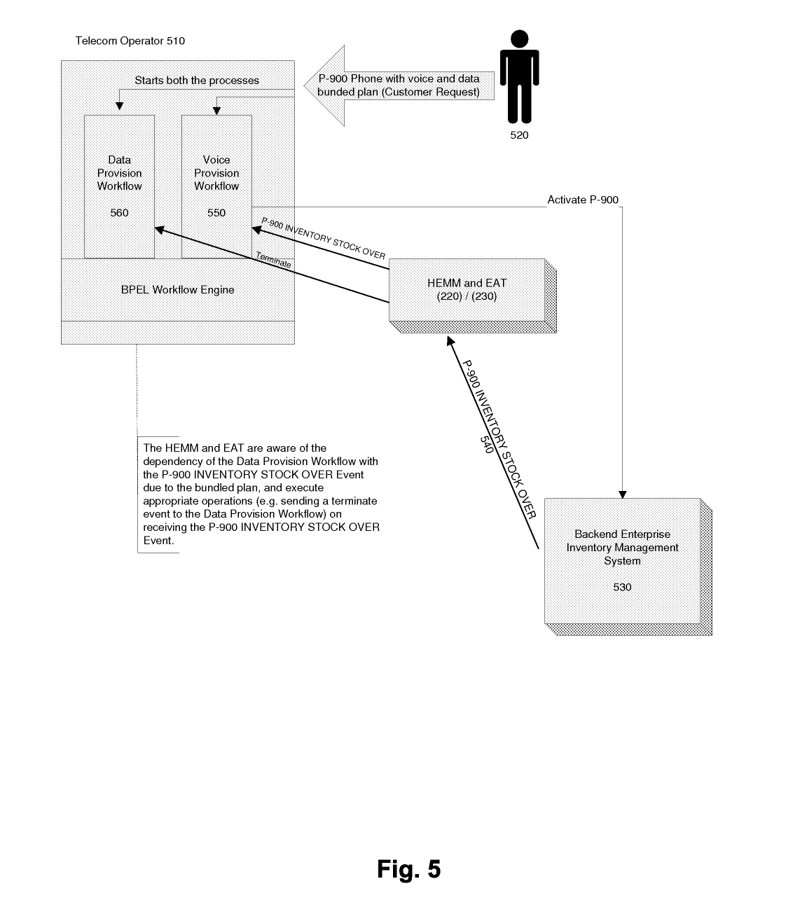

An exemplary application of the workflow system is described with reference to FIG. 5. The workflow system of FIG. 5 includes the HEMM 220 and EAT 203 which are used by external event generation sources (such as the backend enterprise inventory management system) to send events to workflows. In the system of FIG. 5, two workflows 550, 560 have been deployed by the HEMM 220 on the workflow engine with the main objective of provisioning independent voice and data plans to customers. These workflows are long running, and perform a sequence of operations.

The workflow registry 290 and workflow event registry 297 inside the HEMM 220 are automatically populated with information regarding the workflows and events the workflows can handle, at deployment and at workflow initialization times. As hereinbefore described, such information includes, for example, addresses, method names, input messages, output messages, and the like. In the application of FIG. 5, a customer 520 has subscribed to a new bundled voice and data service, which offers discounts on a unified bill at the end of the month, and has requested a P-900 phone that can support the data plan. The customer's request is forwarded to the telecom operator 510 who begins processing the customer's order. Workflows to individually provide voice, and data services (unbundled) to customers have already been implemented by the telecom operator 510.

Upon receiving the request for a bundled service, the HEMM system administrator 250 overviews the request and recognizes that there is a dependency between the voice plan and the data plan. The HEMM system administrator 250 records this dependency in the event dependency registry (EDR) 270. Additionally, the system administrator also recognizes that in the event of a “P-900 Inventory Stock Over” event, the data provision workflow 560 needs to be terminated until the same model is available, whereas, the voice provision workflow 550 can continue and provide the service on another available phone model with an additional discount on the bill. This recognition is registered in the event handling directives module 285 as a corrective action.

During the processing of the order, the backend enterprise inventory management system 530 (siloed and separated from the voice and data workflow management system) registers an event 540 stating that the supply of P-900 phones has run out. This event is sent to and handled by the HEMM 220.

Upon receipt of the “P-900 Inventory Stock Over” event, the HEMM event handler 299 determines from the EDR 270 that the event is a new event having a dependency on two workflows. The HEMM event handler 299 consults the workflow registry 290 to obtain information on which executing workflow correlates to the customer's order, and consults the workflow event registry 297 to determine the events that are recognized by the executing workflow. From the workflow event registry 297, the HEMM event handler 299 determines that the data provisioning workflow does not recognize the “P-900 Inventory Stock Over” event but that the voice provisioning workflow does. In relation to the data provisioning workflow, the HEMM event handler 299 hence calls on the workflow adapter 280 and provides the above information to the workflow adapter 280 to determine the appropriate action to take.

Upon receipt of the above information, the workflow adapter 280 consults the event handling directives module 285 and notes that the system administrator 250 has registered therein that the data provisioning workflow should be terminated upon occurrence of a “P-900 Inventory Stock Over event”. The workflow adapter hence arranges for a “TERMINATE” event (which is an event recognized by the data provisioning workflow) to be sent to the data provisioning workflow. The “TERMINATE” event is sent by the event dispatcher 275 to the data provisioning workflow as instructed by the workflow adapter 280.

It should be noted that, the data provision process is unaware of the occurrence of the “P-900 Inventory Stock Over” event and does not support handling of this event in its workflow schema. Instead, the “P-900 Inventory Stock Over” event is handled by the HEMM 220 on behalf of the data provisioning workflow, and the data provisioning workflow instructed to react appropriate by way of the HEMM 220 sending events recognized by the data provisioning workflow.

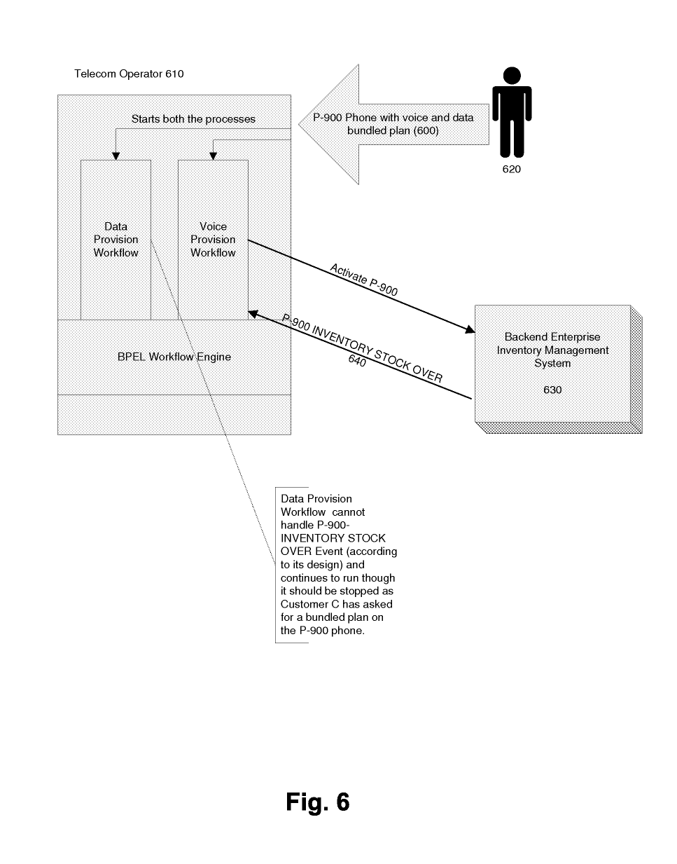

For purposes of comparison, an application of the conventional workflow system to the same system is described with reference to FIG. 6. As was the case above, a customer 620 submits an order 600 for a bundled voice and data service and requests for a P-900 phone that can support the data plan included with the bundled service. The customer's request is forwarded to the telecom operator 610 who begins processing the customer's order.

During the processing of the order, the backend enterprise inventory management system 630 (siloed and separated from the voice and data workflow management system) registers an event 640 stating that the supply of P-900 phones has run out (P-900 Inventory Stock Over event). In contrast to the workflow system of FIG. 5, this event is sent to and handled by the voice provisioning workflow 650. It assumed that the voice provisioning workflow 650 recognizes the “P-900 Inventory Stock Over” event and has appropriate event handlers defined to handled this event. The voice provisioning workflow hence takes appropriate action to, for example, continue voice provisioning on another available phone model.

The data provisioning workflow 660, however, does not receive the “P-900 Inventory Stock Over” event, and in any case, the “P-900 Inventory Stock Over” event is not an event that is recognized by the data provisioning workflow 660. Hence, whilst the data provisioning workflow should also be suspended as it is also affected by the fact that the phone being offered is not available, no such action is taken by the data provisioning workflow. Even if a system administrator were to recognize this problem, the conventional workflow system provides no support to allow the system administrator to inject additional logic to handle this additional dependency without first undeploying the data provisioning workflow.

In order to handle this additional dependency, the running workflow instance of the data provisioning workflow corresponding to the order needs to be stopped, the workflow must be undeployed and reprogrammed, and later re-deployed after the workflow schemas have been reprogrammed. The data provisioning process for this order also needs to be restarted.

As described above, the disclosed invention enables a workflow system to handle new requirements and events without requiring the system to be undeployed and re-deployed each time a change is required to be implemented by the underlying executing workflows.

It is hence possible to integrate event handling across multiple heterogeneous systems. Further, complex status tracking and unforeseen event handling is made possible by the HEMM. Corrective actions may also be specified during run-time, whereby flexibility in mapping events to event handlers may be provided by any external agent including the event generator. Automatic adaptation of corrective actions into backend processes hence enable workflows to accept and adapt to external events unknown at design time.

The foregoing describes only some aspects of this invention, and modifications and/or changes can be made thereto without departing from the scope and spirit of the invention, the aspects being illustrative and not restrictive.

```
APPENDIX A
<eventHandlers>?
    <onMessage partnerLink=″ED″ portType=″AffectedWS“
operation=″Adapt″ variable=″ncname″?>*
    <correlations>?
        <correlation set=″ ″ initiate=″yes|no″>+
    </correlations>
    <!-- activity -->
    <invoke partnerLink=“ToWSAdapter” portType=“Adapter”
operation=“RecResponse”>
        <correlations>
            <correlation set= ” ” pattern=”out”/> //currently
            this is the Order Number.
        </correlations>
    </invoke>
    <receive partnerLink= “FromWSAdapter” portType= “Adapter”
operation= “SendReply” variable=″Action″>
    <switch>
    <case condition=
    ″bpws:getVariableProperty(‘Action’,‘props:totake’)″ >
        <sequence>
        <invoke partnerLink=″customer″
portType=″sns:shippingServiceCustomerPT”
operation=″shippingNotice“  inputVariable=″shipNotice″>
        <correlations>
            <correlation set=″shipOrder″ pattern=″out″/>
        </correlations>
        </invoke>
        </sequence>
    </case>
    <otherwise>
        <terminate/>
    </otherwise>
    </switch>
    </onMessage>
</eventHandlers>
```

We claim:

1. A workflow management method for a workflow system comprising:
registering events recognized by one or more workflows in a workflow event registry;
registering new dependency information in an event dependency registry;
registering corrective actions in an event handling directives module;
upon receipt of an event, identifying workflows that have a dependency associated with the received event;
forwarding the event to dependent workflows which recognize the event;
determining, with reference to the event handling directives module, corrective actions for dependent workflows which do not recognize the event; and
instructing, by way of recognized events the dependent workflows which do not recognize the event to perform the corrective actions.

2. The method of claim 1, wherein the identifying of workflows that have a dependency associated with the received event is performed with reference to the event dependency registry.

3. The method of claim 1, wherein the step of registering new dependency information in the event dependency registry occurs during run-time of the workflow system.

4. The method of claim 1, wherein the step of registering corrective actions in the event handling directives module occurs during run-time of the workflow system.

5. A workflow management system comprising:
a workflow registry adapted to store event handlers defined by workflows;
an event dependency registry operable to receive and store new dependency information identifying workflows dependent on an event; and
an event handler operable to identify events dependent on a received event, and operable to determine, with reference to the workflow registry a first set of one or more workflows, the workflows of the first set being workflows identified as dependent on the received event and for which an event handler adapted to handle the received event has been defined;
wherein the event handler is further operable to forward the received event to the first set of workflows.

6. The workflow management system according to claim 5, further comprising an event handling directives module adapted to store corrective actions.

7. The workflow management system according to claim 6, further comprising a workflow adapter operable to receive from the event handler information regarding a second set of one or more workflows, the workflows of the second set being workflows identified as dependent on the received event but for which no event handler adapted to handle the received event has been defined, wherein
the workflow adapter is further operable to determine, with reference to the event handling directives module, a set of one or more events for which event handlers have been defined in the workflows of the second set, the set of one or more events being operable to effect the corrective actions when handled by respective event handlers of the workflows of the second set, and
the workflow adapter is further operable to cause the set of one or more events to be dispatched to the workflows of the second set.

8. The workflow management system according to claim 5, wherein the event dependency registry is operable to receive and store new dependency information during run-time.

9. The workflow management system according to claim 6, wherein the event handling directives module is adapted to store corrective actions during run-time.
